(19) United States
(12) Patent Application Publication
(10) Pub. No.: US 2018/0045559 A1
(43) Pub. Date: Feb. 15, 2018

(54) SEISMIC INVESTIGATIONS USING SEISMIC SENSOR

(71) Applicant: Schlumberger Technology Corporation, Sugar Land, TX (US)

(72) Inventors: Andrew Hawthorn, Missouri City, TX (US); Joel Herve Le Calvez, Houston, TX (US); Colin Sayers, Katy, TX (US); Jefferson Alford, Sugar Land, TX (US); Edward Michael Tollefsen, Katy, TX (US)

(21) Appl. No.: 15/551,300

(22) PCT Filed: Feb. 25, 2016
(86) PCT No.: PCT/US16/19465

§ 371 Date: Aug. 16, 2017

Related U.S. Application Data
(60) Provisional application No. 62/121,806, filed on Feb. 27, 2015.

(51) Int. Cl. G01H 9/00; E21B 49/00; G01V 1/40

(52) U.S. Cl. CPC G01H 9/004; G01V 1/40; E21B 49/00; G01V 2210/1429; G01V 2210/1425

(57) ABSTRACT

Systems capable of seismically investigating the earth can include seismic sources and a disposable seismic sensor such as a fiber optic seismic sensor included within a drill string. The fiber optic seismic sensor can include a plurality of fiber Bragg gratings. Related methods can include using the seismic sources and the fiber optic seismic sensor to conduct seismic investigations.

### CROSS-REFERENCE TO RELATED APPLICATIONS

This application claims priority to U.S. Provisional Application 62/121,806 filed on Feb. 27, 2015, entitled “Seismic Investigations Using Seismic Sensor,” which is incorporated by reference in its entirety.

### FIELD OF THE INVENTION

Some embodiments described herein generally relate to systems and apparatuses that include disposable seismic sensors for use in seismic investigations of the earth. Additional embodiments generally relate to methods of using disposable seismic sensors to conduct seismic investigations of the earth.

### BACKGROUND

In the drilling of oil and gas wells, information regarding the locations and compositions of oil or gas deposits, and the locations and compositions of other neighboring geologic structures may be collected to aid in drilling the wells. Borehole seismic investigation is of interest to oil and gas exploration professionals because it can provide a deeper penetration into a formation than other available investigation techniques.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one non-limiting embodiment, a system for seismic investigation of the earth is disclosed. The system may include a drill string having a bottom end. The system may also include a fiber optic seismic sensor located in the drill string. The system may also include a drill bit at the bottom end of the drill string.

In another non-limiting embodiment, a method of seismic investigation of the earth is disclosed. The method may include drilling a wellbore into the earth. The method may also include delivering a fiber optic seismic sensor into a drill string within the wellbore. The method may also include activating a seismic source to impart a seismic wave into the earth. The method may also include detecting a reflected portion of the seismic wave at the fiber optic seismic sensor.

In another non-limiting embodiment, a method of seismic investigation of the earth is disclosed. The method may include drilling a wellbore into the earth. The method may also include delivering a fiber optic sensor into a drill string within the wellbore. The method may also include detecting a seismic wave at the fiber optic sensor. The method may also include detecting changes in temperature at the fiber optic sensor.

### BRIEF DESCRIPTION OF THE SEVERAL VIEWS OF THE DRAWINGS

In the drawings, sizes, shapes, and relative positions of elements are not drawn to scale. For example, the shapes of various elements and angles are not drawn to scale, and some of these elements may have been arbitrarily enlarged and positioned to improve drawing legibility.

FIG. 1 depicts a drilling rig and drill string according to one or more embodiments disclosed herein;

FIG. 2 depicts a drilling rig and drill string according to one or more embodiments disclosed herein;

FIG. 3 depicts an optical fiber according to one or more embodiments disclosed herein;

FIG. 4 depicts a fiber core of an optical fiber according to one or more embodiments disclosed herein;

FIG. 5-1 depicts a wide spectrum of light that can be coupled into an optical fiber according to one or more embodiments disclosed herein;

FIG. 5-2 depicts a spectrum of light that can be transmitted through an optical fiber according to one or more embodiments disclosed herein;

FIG. 5-3 depicts a narrow spectrum of light that can be reflected within an optical fiber according to one or more embodiments disclosed herein;

FIG. 6 depicts an optical fiber coupled to a light source and to a light detector according to one or more embodiments disclosed herein;

FIG. 7 depicts an optical fiber coupled to a light source and to a light detector according to one or more embodiments disclosed herein;

FIG. 8 depicts a fiber core of an optical fiber according to one or more embodiments disclosed herein;

FIG. 9 depicts an optical fiber according to one or more embodiments disclosed herein;

FIG. 10 depicts a method of conducting seismic wellbore investigations using a fiber optic seismic sensor according to one or more embodiments disclosed herein; and

FIG. 11 depicts a method of using a fiber optic sensor to detect both seismic waves and temperature changes in a wellbore according to one or more embodiments disclosed herein.

### DETAILED DESCRIPTION

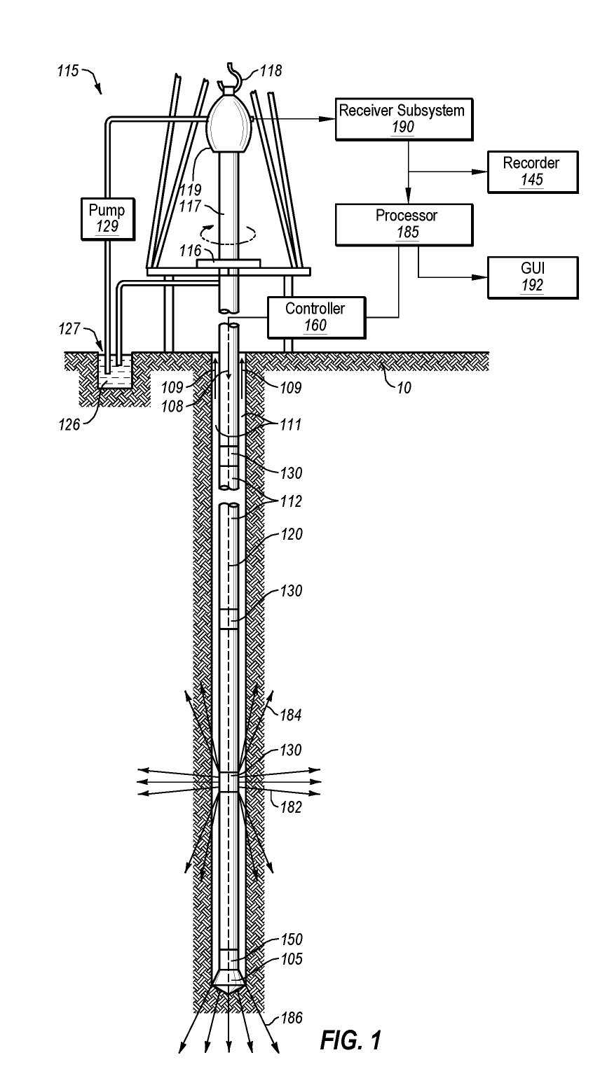

FIG. 1 illustrates a land-based platform and drilling rig 115 positioned over a wellbore 111, and a drill string 112 (on-bottom) for exploring a formation 10. In the illustrated embodiment, the wellbore 111 is formed by rotary drilling. Those of ordinary skill in the art given the benefit of this disclosure will appreciate, however, that the subject matter of this disclosure also finds application in directional drilling applications as well as rotary drilling, and is not limited to land-based rigs.

The drill string 112 is rotated by a rotary table 116, energized by means not shown, which engages a kelly 117 at the upper end of the drill string 112. The drill string 112 is suspended from a hook 118, attached to a travelling block (also not shown), through the kelly 117 and a rotary swivel 119 which permits rotation of the drill string 112 relative to the hook 118. Although depicted with a kelly 117 and rotary table 116 in FIG. 1, in some embodiments, the drill string 112 may be rotated using other methods, such as by using a topdrive.

Drilling fluid 126 (also referred to as drilling mud) is stored in a pit 127 formed at the well site. A pump 129 delivers the drilling fluid 126 to the interior of the drill string 112 via a port in the swivel 119, inducing the drilling fluid 126 to flow downwardly through the drill string 112 as indicated by the directional arrow 108. The drilling fluid 126 exits the drill string 112 via ports in a drill bit 105, and then circulates upwardly through the region between the outside of the drill string 112 and the wall of the wellbore 111, called the annulus, as indicated by the direction arrows 109. In this manner, the drilling fluid 126 lubricates the drill bit 105 and carries formation cuttings up to the surface as drilling fluid 126 returns to the pit 127 for recirculation.

The drill string 112 is suspended within the wellbore 111 and includes the drill bit 105 at its lower, terminal, or bottom end. The drill string 112 can also include a plurality of vibratory tools including vibratory agitators 130 along the length of the drill string 112 and/or a vibratory hammer 150 adjacent or coupled to the drill bit 105, or within one meter of, or within ten meters of, or within twenty meters of, or within fifty meters of, or farther than fifty meters from the drill bit 105. The vibratory agitators 130 may be used to break or lessen the friction within the wellbore 111, such as between an outer surface of the drill string 112 and an inner surface of the wellbore 111. The vibratory hammer 150 may be used to improve a rate of penetration of the drill bit 105 into the formation 10. The vibratory hammer 150 may be used with otherwise seismically quiet drilling systems, such as systems that use a polycrystalline diamond compact cutter as a drill bit, to cause the drill bit 105 to act as both a drilling or cutting tool and a seismic source. The vibratory agitators 130 and the vibratory hammer 150, in the course of performing their respective functions, can generate seismic waves (e.g., pressure or acoustic waves traveling through the earth) which propagate from the respective vibratory tool into the formation 10, or propagate from the vibratory tool through the drill string and drill bit into the formation 10, and thus can be referred to collectively as seismic sources. Seismic sources may also include other tools and structures along the drill string 112, such as valves that control the flow of mud between an internal portion of the drill string 112 and the annulus.

In some embodiments, the downhole seismic sources generate signals ranging in frequency up to 10 kHz. Lower frequency range seismic signals attenuate less in the formation 10 than higher frequency seismic signals, but the lower frequency range seismic signals have a lower resolution than the higher frequency seismic signals. The lower frequency signals may be used to investigate large structures in the formation 10 over long distances. The lower frequency seismic signals may resolve features that are 10 to 100 meters in dimension and up to several kilometers from the seismic sources and seismic sensors, such as when using one or more of the downhole seismic sources with seismic sensors positioned on the ground surface. The higher frequency seismic signals may resolve features in the formation 10 from a quarter meter up to several meters in dimension and hundreds of meters from the source and sensor, such as when using one or more of the downhole seismic sources with one or more of the sensors 120.

The drill string 112 also includes a fiber optic seismic sensor 120 along at least a portion of the length of the drill string 112. The seismic sensor 120 senses seismic waves impacting the drill string 112, such as seismic waves generated at one or more of the seismic sources and reflected back to the drill string 112, such as from interfaces between geologic layers in the formation 10. In some cases, an interface between geologic layers in the formation can include a location at which the composition, structure, or physical or geologic properties change. Various commercially available optical fibers have been found to be suitable for use as the fiber optic seismic sensor 120. Including the seismic sources and the seismic sensor 120 in the drill string 112 allows drilling and seismic investigation to occur at the same time or on the same trip into the wellbore 111.

The seismic sensor 120 can transmit collected data to a receiver subsystem 190, which can be communicatively coupled to a computer processor 185 and a recorder 145. The computer processor 185 may be coupled to a monitor, which can employ a graphical user interface (“GUI”) 192 through which measurements and particular results derived therefrom can be graphically or otherwise presented to the user. The computer processor 185 can also be communicatively coupled to a controller 160. The controller 160 can serve multiple functions, in particular to trigger the start of seismic data acquisition via downlink command. For example, the controller 160 and computer processor 185 may be used to power and operate the seismic sources or the seismic sensor 120. In some cases, the computer processor 185 and the controller 160 can be used to control the frequency and/or amplitude of the seismic waves generated by the seismic sources. Although depicted at the surface, the controller 160 and computer processor 185 may be configured in any suitable manner. For example, the controller 160 and/or computer processor 185 may be part of the drill string 112.

In some embodiments, the systems determine the distance, orientation, or composition of geologic structures, including around the drill string 112 and ahead of the drill bit 105. In some embodiments, the systems are capable of imaging the earth and geologic structures therein up to several kilometers from the seismic sources (e.g., penetration into the surrounding formation). In some embodiments, the systems further include an electronics subsystem having data processing capabilities for determining the distance or orientation of at least a portion of the geologic structures near the drill string 112. For example, the systems can be capable of determining a first, or at least a first, or up to five, or at least five interfaces between geologic layers within the region of the drill string 112. In some embodiments, the systems further include data processing capabilities for determining the composition and properties of the earth, such as seismic velocity (e.g., compression and/or shear velocities), density, or elasticity.

The disclosure also provides methods for downhole seismic investigations. In some embodiments, the methods include obtaining information regarding the earth surrounding the drill string 112 and ahead of the drill bit 105.

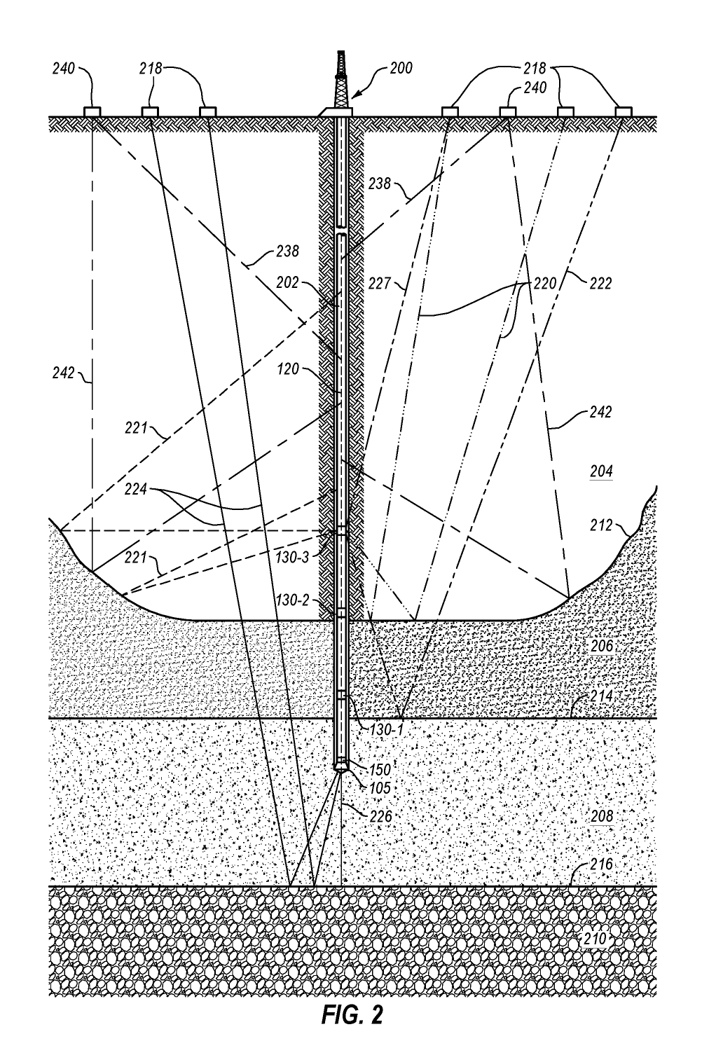

FIG. 2 illustrates a drilling rig 200, which can have a structure similar to that of drilling rig 115, a drill string 202, which can have a structure similar to that of drill string 112, a series of surface seismic sources 240, and a series of surface seismic sensors 218, which can communicate with a computer processor similar to computer processor 185 and a recorder similar to recorder 145, such as through a receiver subsystem similar to the receiver subsystem 190. FIG. 2 illustrates the drill string 202, having the drill bit 105 on-bottom in the wellbore. The drill bit 105 can be used to seismically investigate the earth surrounding the drill string 202, such as the distance and orientation of bed boundaries around the drill string 202 and ahead of the drill bit 105. In particular, the drill string 202 is shown investigating the earth including a first geologic layer 204, a second geologic layer 206, a third geologic layer 208, and a fourth geologic layer 210, as well as a first interface 212 between the first geologic layer 204 and the second geologic layer 206, a second interface 214 between the second geologic layer 206 and the third geologic layer 208, and a third interface 216 between the third geologic layer 208 and the fourth geologic layer 210.

As illustrated in FIG. 2, a vibratory agitator 130-3 can be activated to engage with the formation 10 and to vibrate, thereby generating seismic waves that travel from the vibratory agitator 130-3 into the first geologic layer 204. The vibratory agitators 130 may be located or positioned in the drill string 112 a distance from the drill bit 105, for example at least 10 meters from the drill bit 105. In some embodiments, more than one vibratory agitator 130-1, 130-2, 130-3, is distributed along the drill string. In some embodiments, the vibratory agitator 130 may be located or positioned in the wellbore a distance from the terminal end of the wellbore, for example at least 10 meters from the terminal end of the wellbore.

Seismic waves thus generated can travel outward through the first geologic layer 204 from the drill string 112. Some of the seismic waves 227 travel directly through the formation 10 to one or more of the seismic sensors 218, so-called direct arrival seismic waves. Other seismic waves may travel outward until they encounter an interface, such as the first interface 212, before traveling to one or more of the seismic sensors 218. For example, upon encountering the first interface 212, a portion of a seismic wave can be reflected back into the first geologic layer 204 and another portion can be transmitted into the second geologic layer 206. Reflected portions of the seismic wave (as indicated, for example, by reference numerals 220 and 221) can be detected and wave properties including amplitude and frequency can be measured using the seismic sensor 120 and/or the surface seismic sensors 218. A portion of the wave transmitted through the first interface 212 into the second geologic layer 206 can continue to travel outward through the second geologic layer 206 until the wave encounters the second interface 214, where the wave can again be partially reflected and partially transmitted. A portion of the seismic wave reflected at the second interface 214 (as indicated, for example, by reference numeral 222) can also be detected and wave properties including amplitude and frequency can be measured using the seismic sensor 120 and/or the surface seismic sensors 218. The measured properties of the detected waves can allow the physical locations and orientations of interfaces between geologic layers, and the physical and geologic properties of those geologic layers to be determined.

The vibratory hammer 150 can be activated to vibrate, thereby generating seismic waves that travel from the vibratory hammer 150 into the third geologic layer 208. For example, the vibratory hammer 150 can cause the drill bit 105 to vibrate along the axis of the wellbore (e.g., up and down, or vertically in the illustrated embodiment) so as to impart seismic waves into the third geologic layer 208. As shown in FIG. 2, the drill bit 105 engages with the bottom of the wellbore through direct contact with the bottom of the wellbore (i.e., the drill bit is “on-bottom”), and the vibratory hammer 150 engages with the bottom of the wellbore through the drill bit 105. In other embodiments, the methods and systems described herein can be used while the drill bit 105 is off-bottom. In some embodiments, the drill bit 105 may engage with the sidewalls of the wellbore. In operation, the drill bit 105 drills a wellbore that has the same or similar diameter as the drill bit 105 and therefore, the outer circumference of the drill bit 105 may be in contact with the wellbore.

A seismic wave thus generated can travel outward through the third geologic layer 208 until the wave encounters the third interface 216. Upon encountering the third interface 216, a portion of the seismic wave can be reflected back into the third geologic layer 208 and another portion can be transmitted into the fourth geologic layer 210. Reflected portions of the seismic wave (as indicated, for example, by reference numerals 224 and 226) can continue to be reflected and transmitted at the second interface 214 and first interface 212, and can be detected, and wave properties including amplitude and frequency can be measured, using the seismic sensor 120 and/or the surface seismic sensors 218.

As shown in FIG. 2, the vibratory hammer 150 can generate seismic waves that travel into the third geologic layer 208 through the drill bit 105, thus generating waves that travel out the end of the wellbore, or along an axis coincident with a central axis of the wellbore, or along an axis coincident with at least a terminal end portion of the wellbore (as indicated, for example, by reference numeral 226). In some cases, the fiber optic seismic sensor 120 or the surface seismic sensors 218 can receive and measure seismic waves that travel into the end of the wellbore, or along an axis coincident with a central axis of the wellbore, or along an axis coincident with at least a terminal end portion of the wellbore (as also indicated, for example, by reference numeral 226).

The surface seismic sources 240 can be activated to engage with the formation 10 (for example by vibrating or by other wave inducing techniques known to those of skill in the art), thereby generating seismic waves that travel from the seismic sources 240 into the first geologic layer 204 (as indicated, for example, by reference numerals 238 and 242). Seismic waves thus generated can travel outward through the first geologic layer 204 from the surface seismic sources 240 directly to the seismic sensor 120 (as indicated, for example, by reference numerals 238), so-called direct arrival seismic waves. Other seismic waves thus generated can travel outward through the first geologic layer 204 from the surface seismic sources 240 until they encounter an interface, such as the first interface 212, before traveling to the seismic sensor 120 (as indicated, for example, by reference numerals 242) or one or more of the surface seismic sensors 218 where they can be detected and wave properties including amplitude and frequency can be measured. The measured properties of the detected waves can allow the physical locations and orientations of interfaces between geologic layers, and the physical and geologic properties of those geologic layers, to be determined.

Data collected by the seismic sensor 120 and the surface seismic sensors 218 can be used to determine the locations and orientations of geologic structures, such as geologic layers and interfaces, and to determine the composition or properties of the earth.

The seismic sources can be configured to generate p-waves that travel from the drill string 112 into the formation 10 in directions oriented in the same direction as, along, or at shallow angles with respect to the drill string 112 (e.g., as shown by arrows 184 and 186 in FIG. 1 and reference numeral 220 in FIG. 2) and s-waves that travel more directly outward from the drill string 112 into the formation 10 (e.g., as shown by arrow 182 in FIG. 1 and reference numeral 221 in FIG. 2).

The systems disclosed herein can use a single wellbore or multiple wellbores. For example, in some cases, a first drill string in a first wellbore can include one or more seismic sources and/or one or more seismic sensors and a second drill string in a second wellbore can also include one or more seismic sources and/or one or more seismic sensors. Such systems can provide greater flexibility and more numerous options for relative positioning of seismic sources and seismic sensors. In some cases, multi-wellbore systems may reduce the distance between a seismic source and a seismic sensor, and in particular, facilitate the receipt of s-waves transmitted outwardly from the first wellbore toward the second wellbore.

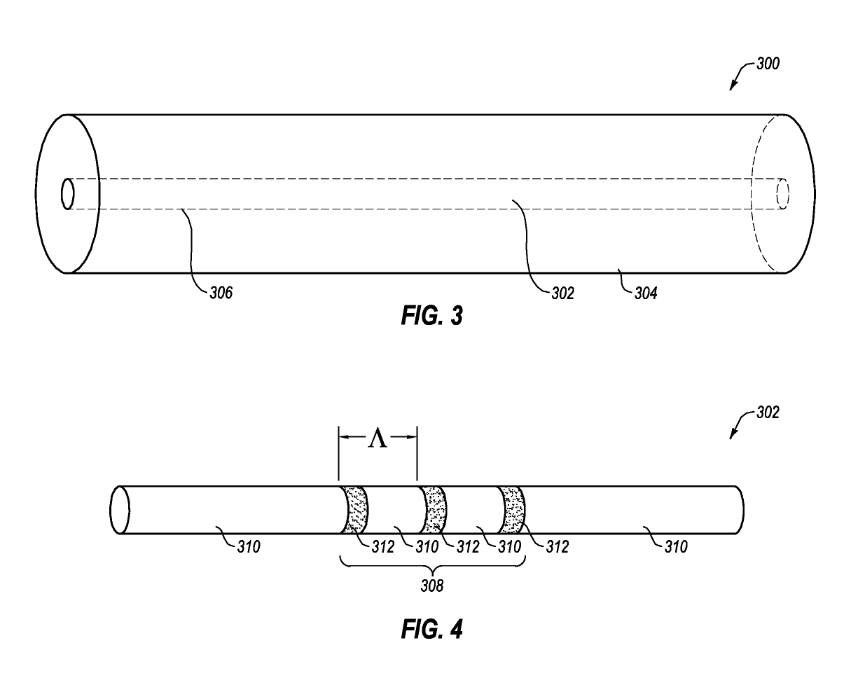

FIG. 3 illustrates an optical fiber 300 which can be used as the fiber optic seismic sensor 120. Optical fiber 300 includes a fiber core 302 having first and second indices of refraction (described in greater detail below), surrounded by a fiber cladding 304 having a third index of refraction. The first, second, and third indices of refraction can be selected such that light propagating through the core 302 is totally internally reflected at an interface 306 between the core 302 and the cladding 304. FIG. 4 illustrates the fiber core 302 in greater detail. The fiber core 302 can include a fiber Bragg grating 308 including first sections 310 of the fiber core 302 having a first index of refraction and second sections 312 of the fiber core having a second index of refraction different from the first index of refraction. By including sections of the fiber core 302 having alternating indices of refraction, the fiber Bragg grating 308 reflects particular wavelengths of light while transmitting others. The particular wavelengths of light reflected by the fiber Bragg grating 308 can be based on the properties of the fiber Bragg grating 308, such as the spacing A between two sections of the fiber core 302 having the same index of refraction (e.g., between two sections 310 or between two sections 312 of the fiber core).

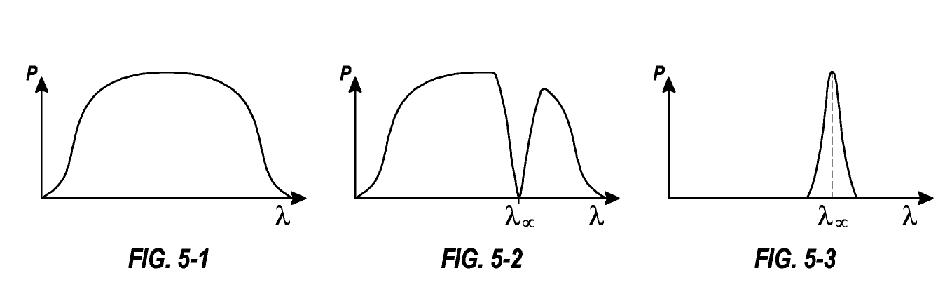

FIGS. 5-1 to 5-3 illustrate an example of the effect of the fiber Bragg grating 308. For example, FIG. 5-1 illustrates a wide spectrum (or broad spectrum) of light that can be coupled into and propagate along the optical fiber 300. FIG. 5-2 illustrates a spectrum of that light that can be transmitted through the fiber Bragg grating, having a relatively narrow spectrum centered at wavelength λ_{α} that is not transmitted, and FIG. 5-3 illustrates the relatively narrow spectrum of the light centered at wavelength λ_{α} that is not transmitted and that is reflected by the fiber Bragg grating 308. As used herein, “wide spectrum” and “narrow spectrum” are relative terms, that is, a “wide spectrum” includes a wider spectrum of wavelengths than a “narrow spectrum.” The terms “wide spectrum” and “narrow spectrum” are not intended to indicate any specific widths of spectrums.

As shown in FIGS. 5-1 to 5-3, a specific wavelength λ_{α} of the propagating light can be reflected by the fiber Bragg grating 308. Because the wavelength λ_{α} can be dependent upon the spacing Λ, changes in the spacing Λ can result in corresponding changes in λ_{α}. For example, in the absence of changes in the spacing Λ (that is, for a baseline spacing Λ_{α}), the fiber Bragg grating 308 can reflect the baseline wavelength λ_{α}. If the fiber Bragg grating 308 experiences a tensile longitudinal strain, Λ can increase to a tensile spacing Λ_{β} and thus λ can increase from the baseline wavelength λ_{α} to a tensile wavelength λ_{β}, by a first change in wavelength Δ_{80 1}, such that λ_{β}=λ_{α}+Δ_{λ1}. If the fiber Bragg grating 308 experiences a compressive longitudinal strain, Λ can decrease to a compressive spacing λ_{γ} and thus λ can decrease from the baseline wavelength λ_{α} to a compressive wavelength λ_{γ}, by a second change in wavelength Δ_{γ2}, such that λ_{γ}=λ_{α}−Δ_{80 2}.

Thus, the optical fiber 300 can function as a seismic sensor. For example, as seismic waves propagate through the optical fiber 300 and its fiber Bragg grating 308, the seismic waves can cause tensile and/or compressive longitudinal strains in the optical fiber 300. In some cases, seismic waves can cause oscillations in the length of the optical fiber 300, thereby inducing alternating tensile and compressive longitudinal strains in the optical fiber 300. The wavelength(s) of light reflected by the fiber Bragg grating 308 (e.g., the tensile wavelength λ_{β} or compressive wavelength λ_{γ}) can be monitored and compared to the baseline wavelength λ_{α} to determine the magnitude of the longitudinal strains induced in the fiber Bragg grating 308 and the optical fiber 300 and thus the magnitude of the seismic waves propagating through the fiber Bragg grating 308 and the optical fiber 300.

The optical fiber 300 can function as a seismic sensor that can detect and measure seismic waves travelling along a central axis of the optical fiber 300, transverse to the central axis of the optical fiber 300, or at any angle with respect to the optical fiber 300. For example, seismic waves travelling along the central axis of the optical fiber 300 can directly induce alternating compressive and tensile longitudinal strains in the optical fiber 300. As another example, seismic waves travelling transverse to the central axis of the optical fiber 300 can indirectly induce alternating compressive and tensile longitudinal strains in the optical fiber 300, such as by directly inducing alternating compressive and tensile transverse strains in the optical fiber 300, which can induce corresponding longitudinal strains according to Poisson's ratio. More specifically, a compressive transverse strain can induce a tensile longitudinal strain and a tensile transverse strain can induce a compressive longitudinal strain.

While the optical fiber 300 represents one example of an optical fiber suitable for use as the fiber optic seismic sensor 120, other suitable optical fibers can be used. For example, an optical fiber including a fiber core having optical elements, such as interfaces between different materials, can be used to selectively reflect specific wavelengths or narrow bands of wavelengths of light at the locations of the respective optical elements along the optical fiber. As another example, optical fibers including Fabry-Pérot etalons or interferometers or other optical elements can be used as the fiber optic seismic sensor 120. As other examples, optical fibers designed to modulate the intensity, phase, polarization, wavelength, or transmit time of light transmitted through or reflected within the optical fiber as a function of pressure encountered by the optical fiber can be used. Further, while an optical fiber such as optical fiber 300 represents one example of a seismic sensor suitable for use as a disposable seismic sensor, other suitable seismic sensors can be used. For example, any suitable seismic sensor, or any plurality of suitable seismic sensors, can be coupled to a cable or wire and used as a disposable seismic sensor in combination with the devices, systems, and methods described herein in the same or in a similar manner as the fiber optic seismic sensor 120.

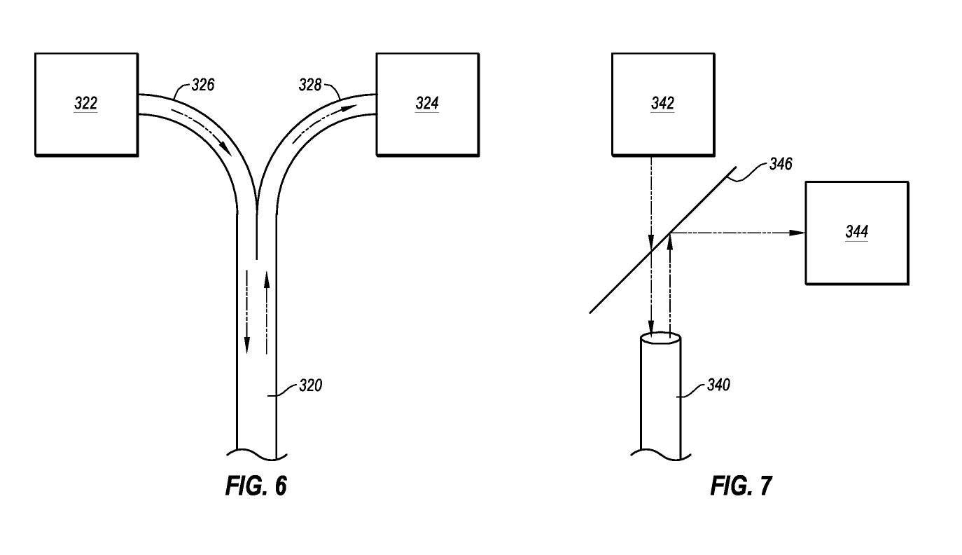

FIG. 6 illustrates another optical fiber 320 which can be used as the fiber optic seismic sensor 120. Optical fiber 320 can be coupled to a light source 322 and a light detector 324. The light source 322 can couple light, such as the relatively wide spectrum light described above, into the optical fiber 320, such as through a first bifurcated portion 326 of the optical fiber 320. Portions of the wide spectrum light can be reflected at locations along the length of the optical fiber 320, and can be coupled from the optical fiber 320 into the light detector 324, such as through a second bifurcated portion 328 of the optical fiber 320. FIG. 7 illustrates another optical fiber 340 which can be used as the fiber optic seismic sensor 120. Optical fiber 340 can be coupled to a light source 342 and a light detector 344. The light source 342 can couple light, such as the relatively wide spectrum light described above, into the optical fiber 340, such as through a semi-transparent mirror 346. Portions of the wide spectrum light can be reflected at locations along the length of the optical fiber 340, and can be coupled from the optical fiber 340 into the light detector 344, such as by the semi-transparent mirror 346.

Light sources suitable for use as light source 322 or light source 324, as well as light detectors suitable for use as light detector 324 or light detector 344, are commercially available. For example, any one of various suitable commercially available optical time-domain reflectometers can be used as a light source and/or a light detector. In some cases, the light detector 324 or the light detector 344 can detect light across a wide spectrum of wavelengths and record the power of the reflected portions of the wide spectrum of wavelengths over time. As one example, commercially available light detectors that include one or more Fabry-Pérot etalons or interferometers can be used. As another example, commercially available tunable light detectors including tunable filters such as Fabry-Pérot etalons or interferometers with movable reflective surfaces can be used to detect the magnitude of relatively narrow spectrums of light.

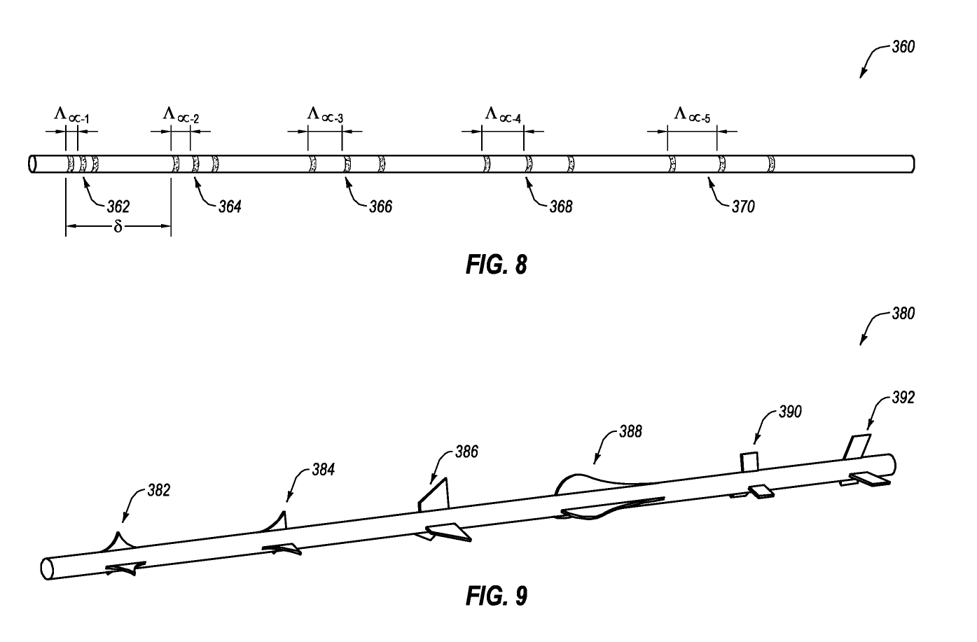

FIG. 8 illustrates a fiber core 360 that can be used as the fiber core of fiber optic seismic sensor 120. Fiber core 360 includes an array of fiber Bragg gratings including a first fiber Bragg grating 362 having a first baseline spacing Λ_{α-1}, a second fiber Bragg grating 364 having a second baseline spacing Λ_{α-2}, a third fiber Bragg grating 366 having a third baseline spacing Λ_{α-3}, a fourth fiber Bragg grating 368 having a fourth baseline spacing Λ_{α-4}, and a fifth fiber Bragg grating 370 having a fifth baseline spacing Λ_{α-5}. The baseline spacing of each of the fiber Bragg gratings 362, 364, 366, 368, and 370 can be different from one another. For example, in some cases, Λ_{α-1}<Λ_{α-2}<Λ_{α-3}<Λ_{α-4}<Λ_{α-5}. In some cases, the baseline spacing of each of the fiber Bragg gratings 362, 364, 366, 368, and 370 can differ from the baseline spacing of each of the others by at least a minimum incremental difference, the minimum incremental difference greater than expected changes to the spacings resulting from seismic waves (e.g., the minimum incremental difference can be greater than Δ_{λ1} and Δ_{λ2}). A fiber core having a plurality of fiber Bragg gratings each having a different baseline spacing, such as fiber core 360, can be used as the fiber core of the fiber optic seismic sensor 120.

For example, wide spectrum light can be continuously coupled into the fiber core 360. The light coupled into the fiber core 360 can comprise a spectrum of wavelengths of light wide enough to include tensile wavelengths λ_{β-1}, λ_{β-2}, λ_{β-3}, λ_{β-4}, λ_{β-5}, and compressive wavelengths λ_{γ-1}, λ_{γ-2}, λ_{γ-3}, λ_{γ-4}, λ_{γ-5} of the fiber Bragg gratings 362, 364, 366, 368, and 370, respectively. Portions of the wide spectrum light reflected within the fiber core 360 can be coupled out of the fiber core 360 and can be monitored and measured. These measurements can be analyzed to determine the wavelengths or narrow spectrums of wavelengths that were reflected within the fiber core 360. By comparing these determined reflected wavelengths to the baseline wavelengths of the fiber Bragg gratings 362, 364, 366, 368, and 370, longitudinal strains at the location of each of the fiber Bragg gratings 362, 364, 366, 368, and 370 can be determined.

These measurements can be made continuously. That is, the wide spectrum light can be coupled into the fiber core 360 continuously and the reflected portions of the wide spectrum light can be measured continuously. This can allow the detection of very brief changes in the longitudinal strain of the fiber core 360 at the location of each of the fiber Bragg gratings 362, 364, 366, 368, and 370. The frequency at which measurements of longitudinal strain can be taken can be limited by the optical detector and data acquisition and analysis equipment being used. Providing the fiber Bragg gratings 362, 364, 366, 368, and 370 with different baseline spacings which differ by at least a minimum incremental difference, as described above, can help ensure that a determined reflected wavelength can be associated with and compared to the baseline wavelength of the fiber Bragg grating from which the determined reflected wavelength was reflected. The fiber core 360 can allow detection of longitudinal strains along the length of the fiber core 360, such as substantially continuously along the length of the fiber core 360. For example, the fiber core 360 can allow detection of longitudinal strains at locations along the length of the fiber core 360 having a resolution (e.g., a smallest measureable interval between the locations) equal to a spacing δ between successive or adjacent fiber Bragg gratings. In some cases, the spacing δ can be less than 10 meters, or less than 1 meter, or less than 10 centimeters, or less than 1 centimeter, or less than 1 millimeter.

In other implementations, rather than continuously coupling wide spectrum light into the fiber core, short pulses of wide spectrum light can be intermittently coupled into the fiber core 360. Portions of the pulses of wide spectrum light reflected within the fiber core 360 can be coupled out of the fiber core 360 and can be monitored and measured, such as to determine the wavelengths or narrow spectrums of wavelengths that were reflected within the fiber core 360. By comparing these determined reflected wavelengths to the baseline wavelengths of the fiber Bragg gratings 362, 364, 366, 368, and 370, longitudinal strains at the location of each of the fiber Bragg gratings 362, 364, 366, 368, and 370 can be determined. The time at which the reflected portions of the pulse are measured can also be recorded, such as to determine the distance the reflected portions of the pulse travelled through the fiber core 360. Determining the distance the reflected portions of the pulse travelled through the fiber core 360 can help to associate the determined reflected wavelengths with the respective fiber Bragg gratings from which the determined reflected wavelengths were reflected, especially in cases where Δ_{80 1} or Δ_{λ2} are large or approach the amount by which Λ_{α-1}, Λ_{α-2}, Λ_{α-3}, Λ_{α-4}, and Λ_{α-5} differ.

Short pulses of wide spectrum light can be coupled into the fiber core 360 and the associated measurements can be made intermittently, such as with a frequency approximating the time it takes light coupled into the fiber core 360 to travel the length of the fiber core 360 twice (i.e., down and back). This can allow the detection of brief changes in the longitudinal strain of the fiber core 360 at the location of each of the fiber Bragg gratings 362, 364, 366, 368, and 370. The frequency at which measurements of longitudinal strain can be taken can be limited by the optical detector and data acquisition and analysis equipment being used, as well as by the frequency with which the short pulses are coupled into the fiber core 360.

FIG. 9 illustrates an optical fiber 380 that can be used as the fiber optic seismic sensor 120. The optical fiber 380 includes a first set of fins 382, a second set of fins 384, a third set of fins 386, a fourth set of fins 388, a fifth set of fins 390, and a sixth set of fins 392, each of the sets of fins comprising fins having shapes different from the shapes of the fins of each of the other sets of fins. In other embodiments, an optical fiber can include a plurality of sets of fins, each of the fins in each of the sets of fins having a shape matching that of the fins of the first set of fins 382, second set of fins 384, third set of fins 386, fourth set of fins 388, fifth set of fins 390, or the sixth set of fins 392. Each of the sets of fins 382, 384, 386, 388, 390, and 392 can include any suitable number of individual fins spaced circumferentially around and coupled to the cladding of the optical fiber 380. Any of the optical fibers described herein can include any number of fins or sets of fins having shapes matching those of the fins illustrated in FIG. 9. In some implementations, a plurality of optical fibers can be wound together to form a single composite optical fiber, and the composite optical fiber can be provided with fins as described above.

In use, the optical fiber 380, a composite optical fiber, or any of the optical fibers described herein, can be delivered to the interior of the drill string 112, for example via the port in the swivel 119, inducing the optical fiber to flow downwardly through the drill string 112 within the drilling fluid 126 as indicated by the directional arrow 108. The optical fiber 380 can be allowed to flow downwardly until a first terminal end portion of the optical fiber 380 reaches or approaches the drill bit 105, at which point the optical fiber can be retained in place, such as by other components coupled to a second terminal end portion of the optical fiber 380 located at or near the drilling rig 115 (e.g., one of the light sources 322 or 324 and/or one of the light detectors 324 or 344). The fins 382, 384, 386, 388, 390, or 392 can help to maintain the stability of the optical fiber 380 within the drilling fluid 126.

Optical fibers can be used as seismic sensors as described herein with very little power. The optical fibers themselves are passive and are operable as sensors as described herein with an amount of power suitable to drive a light source and a light detector. Optical fibers as described herein are also relatively inexpensive and can include no electronic components such that they can be disposable, as described below. Optical fibers are also relatively immune to electromagnetic interference, electrically non-conductive, and resilient when exposed to various pressures and temperatures such that an optical fiber can be used in drilling fluid as described above without substantial damage to the optical fiber.

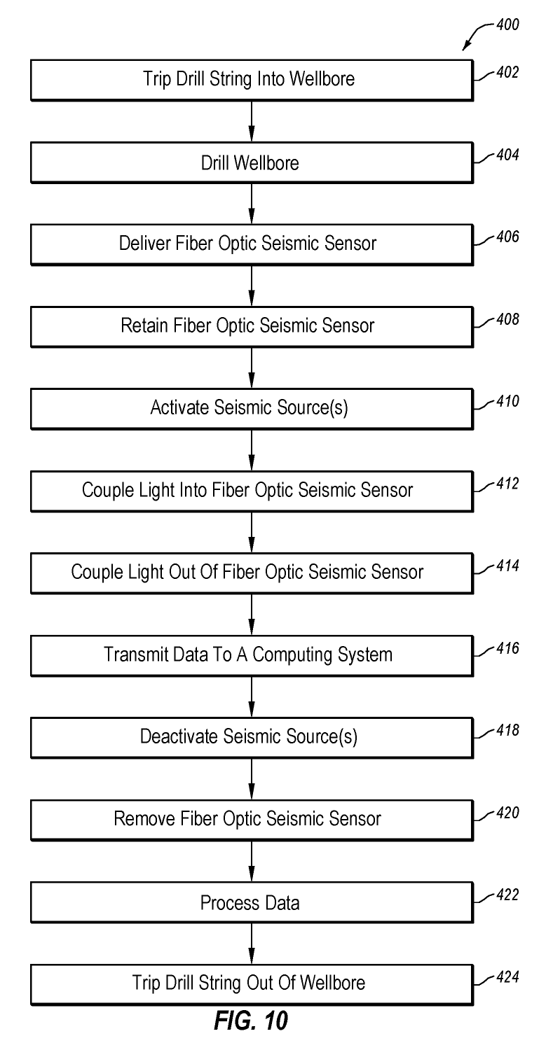

FIG. 10 illustrates a method 400 of conducting seismic wellbore investigations using a fiber optic seismic sensor. At block 402, the method includes tripping a drill string into a wellbore. The drill string can include drill pipe, a bottom hole assembly, a drill bit, and one or more seismic sources such as vibratory agitators 130 or vibratory hammers 150. At block 404, the method includes drilling the wellbore. For example, once the drill string reaches an existing bottom of the wellbore, an operator may begin drilling and extending the wellbore's depth. In some embodiments, for example when a wellbore has collapsed, the operator may begin drilling the wellbore before reaching the bottom of the well. The drilling process may also include other drilling or downhole operations, such as enlarging the wellbore through reaming.

In some implementations, the drill string can include a fiber optic seismic sensor along its length as it is tripped into the wellbore. In other implementations, the drill string does not include a fiber optic seismic sensor along its length as it is tripped into the wellbore, and at block 406, the method includes delivering a fiber optic seismic sensor to the interior of the drill string. In some cases, delivering the fiber optic seismic sensor to the interior of the drill string can include delivering the fiber optic seismic sensor into the drilling fluid flowing downwardly through the drill string. In some cases, delivering the fiber optic seismic sensor to the interior of the drill string can include allowing the fiber optic seismic sensor to travel downwardly through the drill string until a terminal end portion of the fiber optic seismic sensor reaches the drill bit, or until the terminal end portion of the fiber optic seismic sensor is within one meter, or within ten meters, or within twenty meters, or within fifty meters, or within one hundred meters of the drill bit. At block 408, the method includes retaining the fiber optic seismic sensor in place within the drill string.

At block 410, one or more seismic sources, such as a vibratory agitator, a vibratory hammer, or a surface seismic source is activated to generate seismic waves that propagate from the seismic sources into the earth. In some cases, the drilling of the wellbore can be halted so that seismic waves generated by the drilling action of the drill bit do not interfere with those generated by the other seismic sources. In other cases, the drilling of the wellbore can continue, and the drill bit itself can be a seismic source that generates seismic waves to be detected and measured to aid in the seismic wellbore investigations. In some cases, the seismic sources can be activated while the drill bit is on-bottom in the wellbore, and in other cases, the seismic sources can be activated while the drill bit is off-bottom in the wellbore.

The generated seismic waves can be emitted into the earth at a selected fixed frequency and amplitude or the frequency and amplitude may vary according to a selected function or over a selected range. For example, in some embodiments the seismic waves can vary over a frequency range, such as a frequency sweep between a first and a second selected frequency over selected period of time. In some embodiments, the seismic waves may sweep through a frequency band continuously, at periodic intervals, or at aperiodic intervals. In some embodiments, the seismic waves may be emitted at more than one frequency at the same time. For example, each of several seismic emitters may emit seismic waves at a different frequency at the same time. In some embodiments, multiple frequencies of seismic waves are emitted into the earth one at a time, for example, a first frequency is emitted, followed by a second frequency, followed by a third frequency, etc. The generated seismic waves can propagate into the earth, where they can reflect off one or more interfaces between geologic layers.

At block 412, the method includes coupling light from a light source into the fiber optic seismic sensor. Portions of the light coupled into the fiber optic seismic sensor can be reflected at one or more locations within the fiber optic seismic sensor. At block 414, the method includes coupling reflected portions of the light out of the fiber optic seismic sensor into a light detector. Block 412 and block 414 can together be referred to as detecting seismic waves as they travel through the drill string. The detected seismic waves can be direct arrival seismic waves or can be seismic waves that were reflected at least once within the earth. At block 416, data or information regarding the detected seismic waves can be transmitted from the sensors to a computing system including a computer processor and a data storage medium. At block 418, the seismic sources can be deactivated. The seismic sources can be deactivated after the data or information is transmitted to the computing system. At block 420, the fiber optic seismic sensor can be removed from the drill string. In some cases, the fiber optic seismic sensor can be pulled back up through the drill string. In other cases, the fiber optic seismic sensor can be considered disposable and can be disconnected from other equipment at the ground surface, such that the fiber optic seismic sensor can travel down the drill string to the drill bit, and out of the drill string through the drill bit with the drilling fluid. At block 422, the data or information is processed using known seismic data processing techniques to, for example, create visual images of the earth. At block 424, the method includes tripping the drill string out of the wellbore. At least a portion of the drill string may be removed from the wellbore during the trip out.

The method 400 can be performed concurrently with active drilling of the wellbore and can use the same drill string for both drilling operations and the seismic investigations. In some embodiments, by combining the tools for drilling a wellbore and for conducting seismic investigations, well operators can, for example, continue extending the length or depth of the wellbore while also conducting seismic investigations as described herein.

In some cases, optical fibers can be used to measure temperature along the length of the optical fiber. As a first example, changes in temperature can cause corresponding longitudinal strains in the optical fiber. Thus, the methods described above for detecting seismic waves can also be used to measure temperature changes in a wellbore. Generally, the longitudinal strains caused by seismic waves oscillate with a frequency high enough that longitudinal strains caused by changes in temperature do not interfere substantially with the detection of the seismic waves according to the techniques described herein.

As a second example, fiber optic distributed temperature sensing (DTS) systems are generally based on optical time-domain reflectometry (OTDR), which can be referred to as “backscatter.” In this technique, a pulsed-mode high power laser source launches a pulse of light along an optical fiber through a directional coupler. The optical fiber forms the temperature sensing element of the system and is deployed where the temperature is to be measured. As the pulse propagates along the optical fiber its light is scattered through several mechanisms, including density and composition fluctuations (Rayleigh scattering) as well as molecular and bulk vibrations (Raman and Brillouin scattering, respectively). Some of this scattered light is retained within the fiber core and is guided back towards the source. This returning signal is split off by the directional coupler and sent to a highly sensitive receiver. In a uniform fiber, the intensity of the returned light shows an exponential decay with time (and reveals the distance the light traveled down the fiber based on the speed of light in the fiber). Variations in such factors as composition and temperature along the length of the fiber show up in deviations from the “perfect” exponential decay of intensity with distance.

In some applications, the Rayleigh backscatter signature can be examined and the Rayleigh backscatter signature can be unshifted from the launch wavelength. Such a signature provides information on loss, breaks, and inhomogeneities along the length of the fiber, and is very weakly sensitive to temperature differences along the fiber. The two other backscatter components (the Brillouin backscatter signature and the Raman backscatter signature) can be shifted from the launch wavelength and the intensity of these signals can be much lower than the Rayleigh component. The Brillouin backscatter signature and the “Anti-Stokes” Raman backscatter signature are temperature sensitive. Either one (or both) of these backscatter signatures can be extracted from the returning signals by an optical filter and detected by a detector. The detected signals can be processed by the signal processing circuitry, which can amplify the detected signals and then convert (e.g., digitize by a high speed analog-to-digital converter) the resultant signals into digital form. The digital signals may then be analyzed to generate a temperature profile along the optical fiber.

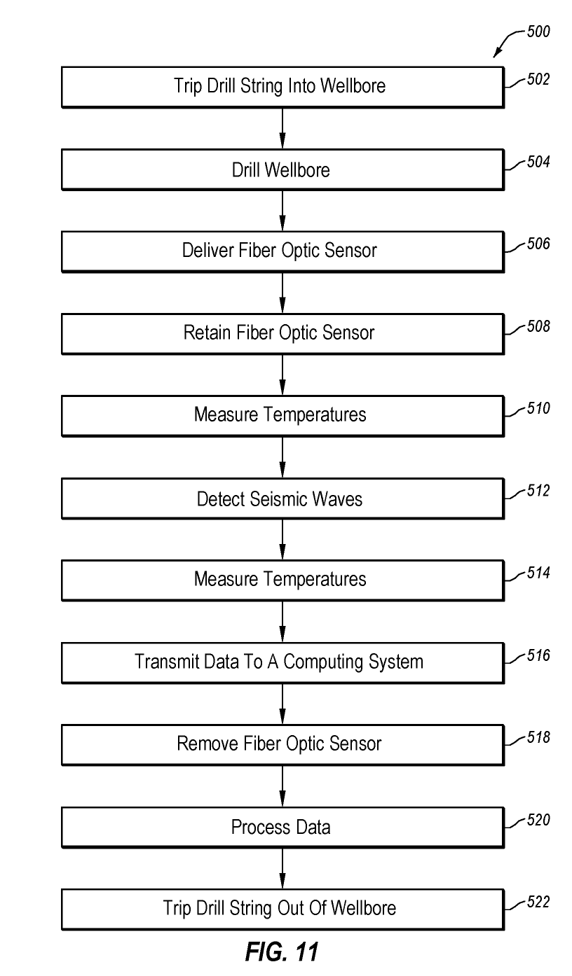

In some cases, a fiber optic seismic sensor, such as any of those described herein, can be used to detect both seismic waves and temperature changes in a wellbore, and thus can be referred to as a fiber optic sensor. For example, FIG. 11 illustrates a method 500 of using a fiber optic sensor to detect both seismic waves and temperature changes in a wellbore. At block 502, the method includes tripping a drill string into a wellbore. At block 504, the method includes drilling the wellbore. At block 506, the method includes delivering a fiber optic sensor to the interior of the drill string. At block 508, the method includes retaining the fiber optic sensor in place within the drill string. At block 510, the method includes using the fiber optic sensor to measure temperatures in the drill string along the length of the drill string. At block 512, the method includes using the fiber optic sensor to detect seismic waves propagating through the drill string. At block 514, the method includes using the fiber optic sensor to measure temperatures in the drill string along the length of the drill string.

At block 516, data or information regarding the measured temperatures and the detected seismic waves can be transmitted from the fiber optic sensor to a computing system including a computer processor and a data storage medium. At block 518, the fiber optic sensor can be removed from the drill string. At block 520, the data or information is processed using known data processing techniques to, for example, create visual images of the earth or generate a temperature profile along the length of the optical fiber. At block 522, the method includes tripping the drill string out of the wellbore.

By combining the tools for drilling a wellbore, for conducting seismic investigations, and for measuring temperatures, well operators can, for example, continue extending the length or depth of the wellbore while also conducting seismic investigations and measuring temperatures as described herein.

A few example embodiments have been described in detail above; however, those skilled in the art will readily appreciate that many modifications are possible in the example embodiments without materially departing from the scope of the present disclosure or the appended claims. Accordingly, such modifications are intended to be included in the scope of this disclosure. Likewise, while the disclosure herein contains many specifics, these specifics should not be construed as limiting the scope of the disclosure or of any of the appended claims, but merely as providing information pertinent to one or more specific embodiments that may fall within the scope of the disclosure and the appended claims. Any described features from the various embodiments disclosed may be employed in combination. In addition, other embodiments of the present disclosure may also be devised which lie within the scope of the disclosure and the appended claims. Additions, deletions and modifications to the embodiments that fall within the meaning and scopes of the claims are to be embraced by the claims.

Certain embodiments and features may have been described using a set of numerical upper limits and a set of numerical lower limits. It should be appreciated that ranges including the combination of any two values, e.g., the combination of any lower value with any upper value, the combination of any two lower values, or the combination of any two upper values are contemplated. Certain lower limits, upper limits and ranges may appear in one or more claims below. Numerical values are “about” or “approximately” the indicated value, and take into account experimental error, tolerances in manufacturing or operational processes, and other variations that would be expected by a person having ordinary skill in the art.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include other possible embodiments along with the full scope of equivalents to which such claims are entitled. Accordingly, the claims are not limited by the disclosure.

1. A system for seismic investigation of the earth, comprising:
a drill string having a bottom end;
a fiber optic seismic sensor located in the drill string; and
a drill bit at the bottom end of the drill string.

2. The system of claim 1, wherein the fiber optic seismic sensor is disposable.

3. The system of claim 1, further comprising a seismic source located in the drill string.

4. The system of claim 1, wherein the fiber optic seismic sensor includes a fiber Bragg grating.

5. The system of claim 4, wherein:
the fiber Bragg grating is a first fiber Bragg grating; and
the fiber optic seismic sensor includes a second fiber Bragg grating.

6. The system of claim 5, wherein the first fiber Bragg grating is configured to reflect a first wavelength of light and the second fiber Bragg grating is configured to reflect a second wavelength of light different from the first wavelength of light.

7. The system of claim 1, wherein the fiber optic seismic sensor includes a plurality of fiber Bragg gratings spaced apart from one another by less than 1 centimeter.

8. The system of claim 7, wherein the plurality of fiber Bragg gratings are spaced apart from one another by less than 1 millimeter.

9. A method of seismic investigation of the earth, comprising:
drilling a wellbore into the earth;
delivering a fiber optic seismic sensor into a drill string within the wellbore;
activating a seismic source to impart a seismic wave into the earth; and
detecting a reflected portion of the seismic wave at the fiber optic seismic sensor.

10. The method of claim 9, further comprising removing the fiber optic seismic sensor from the drill string.

11. The method of claim 10, wherein removing the fiber optic seismic sensor from the drill string comprises pulling the fiber optic seismic sensor up through the drill string.

12. The method of claim 10, wherein removing the fiber optic seismic sensor from the drill string comprises allowing the fiber optic seismic sensor to travel out of the drill string through a drill bit at a bottom end of the drill string.

13. The method of claim 9, wherein detecting a reflected portion of the seismic wave at the fiber optic seismic sensor comprises coupling light into the fiber optic seismic sensor and coupling reflected portions of the light out of the fiber optic seismic sensor.

14. The method of claim 13, further comprising transmitting data associated with the reflected portions of the light to a computing system.

15. The method of claim 14, wherein the fiber optic seismic sensor includes a plurality of fiber Bragg gratings and wherein the method further comprises associating each of the reflected portions of the light with a respective one of the fiber Bragg gratings.

16. The method of claim 15, further comprising determining a longitudinal strain at each of the fiber Bragg gratings by comparing the reflected portions of the light to baseline wavelengths associated with each of the fiber Bragg gratings.

17. A method of seismic investigation of the earth, comprising:
drilling a wellbore into the earth;
delivering a fiber optic sensor into a drill string within the wellbore;
detecting a seismic wave at the fiber optic sensor; and
detecting changes in temperature at the fiber optic sensor.

18. The method of claim 17, wherein the detecting a seismic wave at the fiber optic sensor comprises coupling light into the fiber optic sensor and coupling reflected portions of the light out of the fiber optic sensor.

19. The method of claim 18, wherein detecting changes in temperature at the fiber optic sensor comprises analyzing the reflected portions of the light to assess spectral compositions of the reflected portions of the light.

20. The method of claim 18, wherein detecting changes in temperature at the fiber optic sensor comprises using optical time-domain reflectometry.
